(19) United States
(12) Patent Application Publication
(10) Pub. No.: US 2003/0129973 A1
(43) Pub. Date: Jul. 10, 2003

(54) Method for providing information reflecting mobile user action, and mobile switching center, information providing apparatus, and mobile unit implementing the same

(76) Inventors: Yuichiro Oishi, Fukuoka (JP); Soichi Kuwahara, Fukuoka (JP)

Correspondence Address: KATTEN MUCHIN ZAVIS ROSENMAN, 575 MADISON AVENUE, NEW YORK, NY, 10022-2585, US

(21) Appl. No.: 10/337,209

(22) Filed: Jan. 6, 2003

(30) Foreign Application Priority Data
Jan. 7, 2002 (JP) 2002-000676
Sep. 4, 2002 (JP) 2002-259168

(51) Int. Cl. H04M 3/42; H04Q 7/20

(52) U.S. Cl. 455/414; 455/445

(57) ABSTRACT

The invention makes it possible to quickly confirm the safety of people in an area stricken by a disaster such as an earthquake while protecting people's privacy, even in a situation where communication calls cannot be established due to network congestion. An event reflecting an action of the user of a mobile unit in a designated area, such as a change in the location registration of the mobile unit, is detected by a user event detecting unit 18. in mobile switching equipment 12, and stored in a user event storing unit 22 in an information providing apparatus 16. In an information providing method, when there is an incoming call to a mobile unit in the designated area, for example, if the call cannot be established due to network congestion, the call is connected to an information providing unit 24 which provides user action information, by voice, to the calling party.

### BACKGROUND OF THE INVENTION

1. Field of the Invention

The present invention relates to a method for communicating information concerning a mobile user to a third party, and a mobile switching center, an information providing apparatus, and a mobile unit implementing the same; more particularly, the invention relates to a method for providing user information by monitoring the state of a mobile unit located in a designated area in the event of an emergency such as a disaster, and a mobile switching center, an information providing apparatus, and a mobile unit implementing the same.

2. Description of the Related Art

In the Great Hanshin-Awaji Earthquake of 1995, telephone calls from people in the disaster stricken area trying to inform their relatives, etc. of the safety of themselves and of their family members, as well as telephone calls from outside the stricken area trying to check on or inquire about the safety of the affected people, flooded the stricken area and the trunk exchanges in the area were thrown into a congestion state, causing a serious problem that most of the inquiring calls could not be connected. The telephone is the means most used to inquire about people's safety in the event of a disaster, but the reality is that the telephone does not serve the purpose as a means of inquiring about people's safety, for the reasons stated above. Congestion could be avoided by increasing the number of lines or boosting the processing capacity, but this is not easily feasible economically. Further, in mobile communication networks, it is difficult to increase the number of lines because of the physical limitations of radio bands allocated to communications. Therefore, congestion is an unavoidable problem as long as the telephone is used as a means for inquiring about people's safety.

In view of the above problem, various systems have been developed to provide methods for inquiring about people's safety in the event of a disaster. One example is the “Disaster Emergency Dengon (Messaging) Dial” system. In this system, people in the stricken area access a message storage device and record messages about their safety, and the recorded messages are distributed over about 50 centers located across Japan so that people outside the stricken area can readily check on the safety of the people living in the stricken area, while effectively preventing congestion from occurring due to calls flooding into the area.

The feature common to such systems is that they are effective only after a certain period of time has elapsed from the occurrence of a disaster. It is difficult to say that the “Disaster Emergency Dengon Dial” system can provide quick safety inquiry service immediately after the occurrence of a disaster, because the time at which the system becomes available for service, the telephone numbers that can be registered, and the method and conditions of operation are set by the communication carrier according to the situation and made public by television, radio, or like means. Furthermore, as this system requires that both the person who desires to store his message and the person who desires to know the safety of the other party access the system, the safety of the other party cannot be confirmed unless both parties access the system. In any case, it cannot be said that the system can provide quick safety inquiry service immediately after the occurrence of a disaster. As such a disaster-specific system is one that users never use unless a disaster actually happens, the essential point is whether a user unfamiliar with the operation can use the system correctly.

For the reasons stated above, it can be said that it is difficult for both parties to confirm their safety immediately after the occurrence of a disaster even if the “Disaster Emergency Dengon Dial” service is used. However, in such cases, even though a safety inquiry cannot be made by voice communication, if there is any method by which one party can check on the safety of the other party, information obtained by such a method will be very useful and will serve to alleviate the irritation and uneasiness arising in both parties from an inability to communicate with each other.

Mobile telephones rapidly spreading in recent years (about 67 million users in Japan as of Mar. 31, 2001) have become a social infrastructure indispensable to our lives. A variety of functions and services have been made available to the users, and it has become possible to keep track of the state of each user by providing information about the mobile telephone that the user carries. A familiar example is the “Imadoko (Where are you) service”, a location information service provided by NTT DoCoMo. A subscriber to this service can see on a map the approximate location of a subscribed mobile unit in the current PHS area. In this system, a location information center is provided on the network, and when the user accesses a system server at the center via the Internet, FAX, or other means, and enters his secret code number preassigned for privacy protection, the user can obtain location information about the subscribed mobile unit. Using this service, it is possible to gather user information even in the event of a line congestion.

If such a location information service is used as a means for inquiring about people's safety in the event of a disaster, there arises a privacy problem because the user may not want his location information to be made available to a third party; when this coupled with the limitation that no one other than the subscribers to the service is allowed to use the service, it is difficult to use such a service as a means of safety inquiry for unspecified individuals in the event of a disaster. Furthermore, this service is intended to indicate the current location of the mobile user; it does not provide information as to whether the user has actually moved, nor does it provide information directly indicating a user action.

Further, in the case of the “Disaster Emergency Dengon dial” system, as it takes a finite time before the system can be made available for service, and since both parties are required to access the system if one wants to know the safety of the other party, as earlier described, it cannot be said that quick safety inquiry can be accomplished in the event of a disaster.

### SUMMARY OF THE INVENTION

It is an object of the present invention to provide a method that can communicate a user state, such as the safety of the user, to a third party in the event of a disaster or other unexpected situation, while maximally protecting user privacy such as user location, etc. It is also an object of the invention to provide a mobile switching center and an information providing apparatus implementing such a method.

According to the present invention, there is provided a mobile switching center comprising: means for detecting an action of the user of a mobile unit; and means for transmitting the detected action information in order to have the action information stored in association with the mobile unit and to have the action information be provided.

According to the present invention, there is also provided an action information providing apparatus comprising: means for receiving information reflecting an action of the user of a mobile unit; means for storing the received action information in association with the mobile unit; and means for providing the action information.

This action information includes, for example, information indicating whether the mobile unit has moved from one location registration area to another and not information directly indicating the location registration area where the mobile unit is registered.

According to the present invention, there is also provided a mobile unit comprising: means for detecting information reflecting an action of the user of the mobile unit; and means for reporting the detected action to a network.

The action information detected at the mobile unit includes, for example, information indicating that the user performed an operation on the mobile unit or that the base station serving the mobile unit is changed.

As can be seen from the above example, the action information according to the present invention does not include information irrelevant to the movement of the user, such as information indicating the current location of the mobile unit, but includes information only indicating that the user has performed a certain kind of action. By storing such information and providing it as needed, the safety of the mobile user can be made known to the inquiring party, for example, in the event of a disaster.

### BRIEF DESCRIPTION OF THE DRAWINGS

FIG. 1 is a block diagram showing one embodiment of an information providing system according to the present invention;

FIG. 2 is a block diagram showing the detailed configuration of mobile switching equipment 12 shown in FIG. 1;

FIG. 3 is a block diagram showing the detailed configuration of an information providing apparatus 16 shown in FIG. 1;

FIG. 4 is a diagram for explaining how the location registration area size is changed;

FIG. 5 is a diagram for explaining how the location registration area size is changed on a group-by-group basis;

FIG. 6 is a block diagram showing a network configuration for the information providing system of the present invention;

FIG. 7 is a flowchart illustrating the operation of a location changing mobile unit information detecting unit 36; FIG. 8 is a flowchart illustrating the operation of a call initiating mobile unit information detecting unit 38;

FIG. 9 is a flowchart illustrating the operation of a voice communicating mobile unit information detecting unit 40;

FIG. 10 is a flowchart illustrating the operation of a personal user registration detecting unit 42;

FIG. 11 is a flowchart illustrating the operation performed at mobile switching center when a call arrives from a mobile unit;

FIG. 12 is a block diagram showing the configuration of a mobile switching center and a base station according to a second embodiment of the present invention;

FIG. 13 is a block diagram showing the configuration of a mobile unit according to the second embodiment of the present invention;

FIG. 14 is a flowchart illustrating the processing performed when the mobile unit received a user event detection instruction;

FIG. 15 is a flowchart illustrating a process for detecting a change in the location detected by GPS;

FIG. 16 is a flowchart illustrating the processing performed when a password is entered;

FIG. 17 is a flowchart illustrating the processing performed when an emergency message is entered;

FIG. 18 is a flowchart illustrating the processing performed when broadcast information is received;

FIG. 19 is a flowchart illustrating the processing performed when the broadcast information is received;

FIG. 20 is a diagram showing a location registration sequence for user event notification;

FIG. 21 is a diagram showing a location registration sequence that includes the transportation of an emergency message; and

FIG. 22 is a diagram showing a location registration message.

### DESCRIPTION OF THE PREFERRED EMBODIMENTS

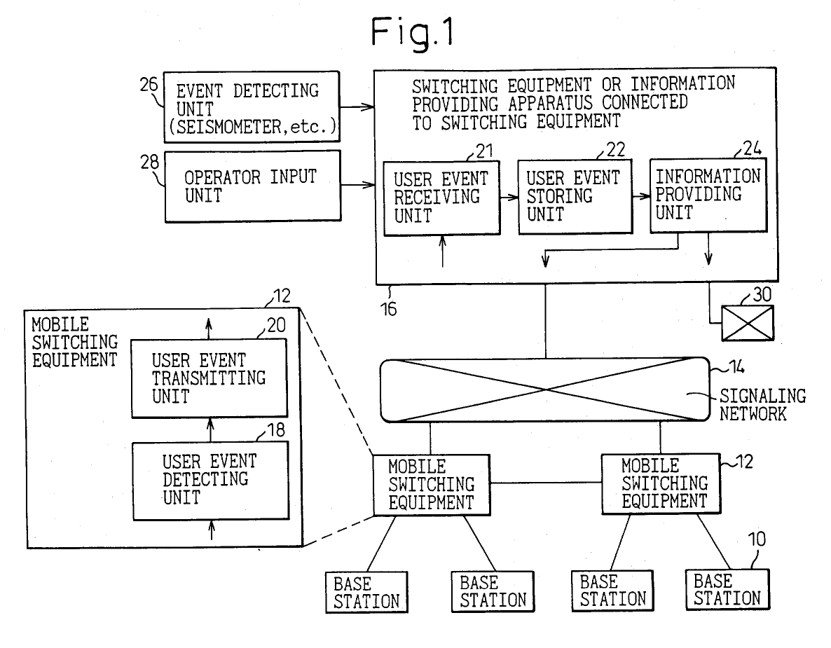

FIG. 1 shows one embodiment of an information providing system according to the present invention. Mobile switching equipment 12 is connected via a signaling network 14 to switching equipment or an information providing apparatus 16 connected to the switching equipment (hereinafter referred to as the information providing apparatus 16).

The mobile switching equipment 12 comprises a user event detecting unit 18 for detecting actions of the users of mobile units (not shown) located within the areas covered by the base stations 10 connected to the mobile switching equipment 12, and a user event transmitting unit 20 for transmitting information concerning the user actions detected by the user event detecting unit 18 to the information providing apparatus 16 via the signaling network 14. Mobile user action information includes, for example, the following events.

(1) The location registration area in which the mobile unit is registered is changed.

(2) A call is made from the mobile unit (and/or an incoming call to the mobile unit is answered). This can be regarded as a call initiating or call answering action performed by the user of the mobile unit.

(3) Voice communication has lasted for more than a predetermined length of time.

(4) The mobile unit used is changed (in the case of a personal communication system).

(5) Data communication is initiated from the mobile unit.

Here, the event (1) that the location registration area is changed indicates that the user of the mobile unit has moved from one area to another. Usually, one location registration area is made up of the areas covered by a plurality of base stations; therefore, if the system is reconfigured by reducing the number of base stations forming one location registration area and thereby making the location registration area smaller, as will be described later, the resolution of detection can be increased. The action information provided in this case is not the location information indicating where the mobile is located, but only provides the fact that the user has moved from area to area.

The event (2) that a call is made from the mobile unit indicates that the user has performed a call initiating operation. Likewise, the operation performed to answer an incoming call reflects the user's action, provided that the mobile unit is one equipped with an automatic answering function. The condition in the event (3) that voice communication “last for more than a predetermined length of time” is to distinguish it from the communication initiated by the automatic answering action of an answering machine function. The personal communication system in the event (4) is a system that allows the user to use any desired mobile unit by inserting therein an IC card or the like on which the user identifying personal number is recorded, and the fact that the mobile unit used is changed means that the user has performed an operation to insert the IC card into the mobile unit.

The information providing apparatus 16 comprises a user event receiving unit 21 for receiving the action information transmitted from the user event transmitting unit 20 in the mobile switching equipment 12, a user event storing unit 22 for storing the action information received by the user event receiving unit 21, and an information providing unit 24 for providing the information stored in the user event storing unit 22 to a third party.

An area for information providing service is specified from an operator input unit 28, such as a maintenance terminal, connected to the information providing apparatus 16. An event detecting unit 26 detects the occurrence of any prespecified event (for example, an earthquake with a seismic intensity of 6 or greater) in collaboration with a measuring instrument such as a seismometer, seismic intensity meter, etc., and automatically determines an area of up to a predetermined distance from the epicenter as the information providing service area. For example, action information concerning the mobile units registered in the location registration areas within the thus determined service area is provided, but information concerning the mobile units outside the service area is not provided.

Modes of the information providing from the information providing apparatus 24 include the following.

(1) Voice announcement as a response to a call made to a mobile unit located in the designated area.

(2) Information providing via the Internet 30 in response to a request made from a computer via-the Internet 30.

(3) Notification by telephone or electronic mail to a preregistered recipient's telephone number or electronic mail address.

In the modes (1) and (2), provisions may be made to limit the recipients of the user information by allowing only preregistered terminals (or users) to receive the information or by requiring the entry of a password.

In the above embodiment, the user event detecting unit 18 and the information providing unit 24 are provided in the mobile switching equipment 12 and the information providing apparatus 24, respectively, but they may be provided in the same equipment or apparatus; such a configuration also falls within the scope of the present invention. In that case, the user event transmitting unit 20 and the user event receiving unit 21 can be omitted.

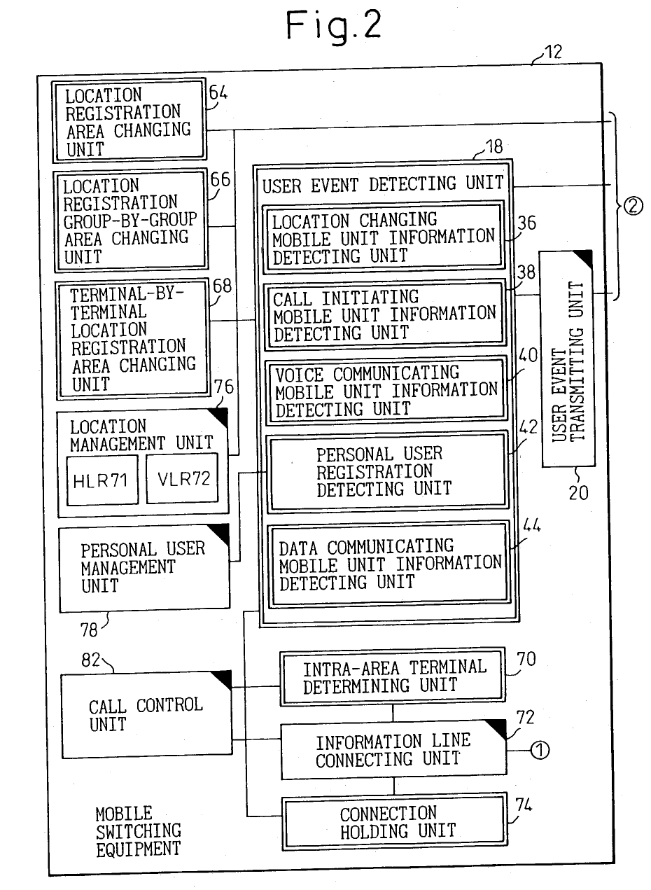

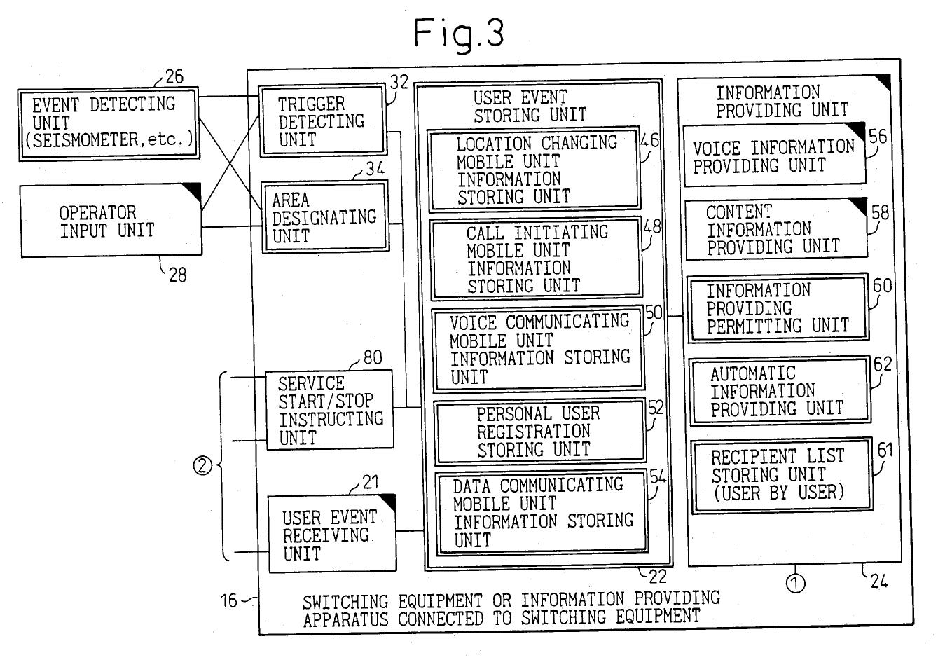

FIGS. 2 and 3 show examples of the detailed configurations of the mobile switching equipment 12 and the information providing apparatus 16 shown in FIG. 1, respectively. In FIGS. 2 and 3, blocks marked with a black triangle in the upper right corner are functional blocks modified from those used in existing mobile communication systems, blocks enclosed by double frames are newly provided functional blocks, and the other blocks are the same functional blocks as those used in the existing mobile communication systems.

In the information providing apparatus 16 (FIG. 3), a trigger detecting unit 32 detects an input from the operator input unit 28 or the event detecting unit 26, and activates the service. An area designating unit 34 designates the service area based on the input from the event detecting unit 26 or the operator input unit 28.

In the mobile switching equipment 12 (FIG. 2), a location changing mobile unit information detecting unit 36 in the user event detecting unit 18 detects that the location registration area is changed as the terminal moves. The event that the change of the location registration area is detected means that the person carrying the mobile unit has moved into another area. This detection can be accomplished by monitoring whether the location registration area of the mobile unit is changed or not; more specifically, when the location registration area of the MLR mobile unit is changed to a new area (location updating), it can be determined that a change has been detected. A call initiating mobile unit information detecting unit 38 detects that the user has initiated a call. The call initiating mobile unit information detecting unit 38 detects the event of call initiation even when the call fails to get through. The call initiation event means that the user has initiated the call by operating the mobile unit. This detection can be accomplished by detecting the reception of a call request message from the mobile unit. A response made to an incoming call to the mobile unit can also be detected as an event indicating the action of the mobile user. This means that the user has operated the mobile unit to answer the incoming call, unless the mobile terminal is one equipped with an automatic answering function. This detection can be accomplished by monitoring for a call answered signal that arises when the mobile unit responds to an incoming call. A voice communicating mobile unit information detecting unit 40 detects any mobile unit having performed a voice communication for more than a predetermined length of time. Preferably, in order to avoid mistakingly detecting the automatic answering by an answering machine function as an event indicating the action of the mobile user, the voice communicating mobile unit information detecting unit 40 detects the operation of the mobile unit as a user initiated event when the voice communication has lasted for a time longer than the time preset by the answering machine function. The event that the voice communication has lasted for more than the predetermined length of time indicates that the user of that mobile unit has actually made a voice communication. A personal user registration detecting unit 42 detects that, in a personal communication system, the user has performed a user registration on the communication terminal he uses. Here, the personal communication system is a communication system in which each user is assigned a unique number (personal number) and, when a user registration is made on a desired communication terminal by using the personal number, the user can make and receive calls using the user registered terminal. Methods of personal user registration include a method in which the registration is made by inserting a personal card holding the personal number thereon into the desired terminal, and a method in which the registration is made by entering the personal number and secret code number from the communication terminal. The event that the user has performed the registration on the terminal indicates the user's autonomous action performed to register the terminal. A data communicating mobile unit information detecting unit 44 detects that the terminal has initiated a data communication call by transmitting packets or by using a fax, modem, or other suitable means. This event indicates the user's autonomous action performed to initiate the data communication.

In the information providing apparatus 16 (FIG. 3), a location changing mobile unit information storing unit 46 in the user event storing unit 22 stores the event, detected by the location changing mobile unit information detecting unit 36 (FIG. 2), that the location of the mobile unit has changed. A call initiating mobile unit information storing unit 48 (FIG. 3) stores the event, detected by the call initiating mobile unit information detecting unit 38 (FIG. 2), that the mobile unit has initiated a call. A voice communicating mobile unit information storing unit 50 (FIG. 3) stores the event, detected by the voice communicating mobile unit information detecting unit 40 (FIG. 2), that the mobile unit has performed a voice communication for more than the predetermined length of time. A personal user registration storing unit 52 (FIG. 3) stores the event, detected by the personal user registration detecting unit 42 (FIG. 2), that the user has changed the registered terminal to another terminal. A data communicating mobile unit information storing unit 54 (FIG. 3) stores the event, detected by the data communicating mobile unit information detecting unit 44 (FIG. 2), that the mobile unit has performed a data communication by suitable means.

A voice information providing unit 56 in the information providing unit 24 (FIG. 3) provides information by voice when an access is made from a voice terminal such as a telephone to a mobile unit located within the service providing area. A content information providing unit 58 provides user information in the form of information that can be acquired from a data network when an access is made from a personal computer or the like to the mobile unit via a data network such as the Internet. An information providing permitting unit 60 restricts the terminals or users that are allowed to acquire information from the information providing unit 24. To accomplish this, user information is provided only when an access is made from a preregistered terminal (or user), or only a person who knows the preassigned password is permitted to access the user information. A recipient list storing unit 61 registers and stores a list of recipients (telephone numbers, electronic mail addresses, etc.) to whom the user wants the user information to be automatically transmitted when the service is activated (in the event of a disaster or the like). An automatic information providing unit 62, based on the information stored in the user event storing unit 22, creates the information to be provided and automatically transmits the information to the destinations stored in the recipient list storing unit 61. When the destination registered in the recipient list storing unit 61 is a telephone number, the information is automatically provided in the form of a voice message, while when the registered destination is an electronic mail address, the information is delivered in the form of text mail or the like.

In the mobile switching equipment 12 (FIG. 2), a location registration area changing unit 64 changes the size of the mobile unit location registration area in the area designated by the area designating unit 34 in the information providing apparatus 16 (FIG. 3). When the location registration area size is made smaller than the normal size, the frequency of occurrence of mobile unit registrations increases, and the location change detection rate can thus be increased.

Before going into the detail of the location registration area changing unit 64, a prior art location registration technique will be described.

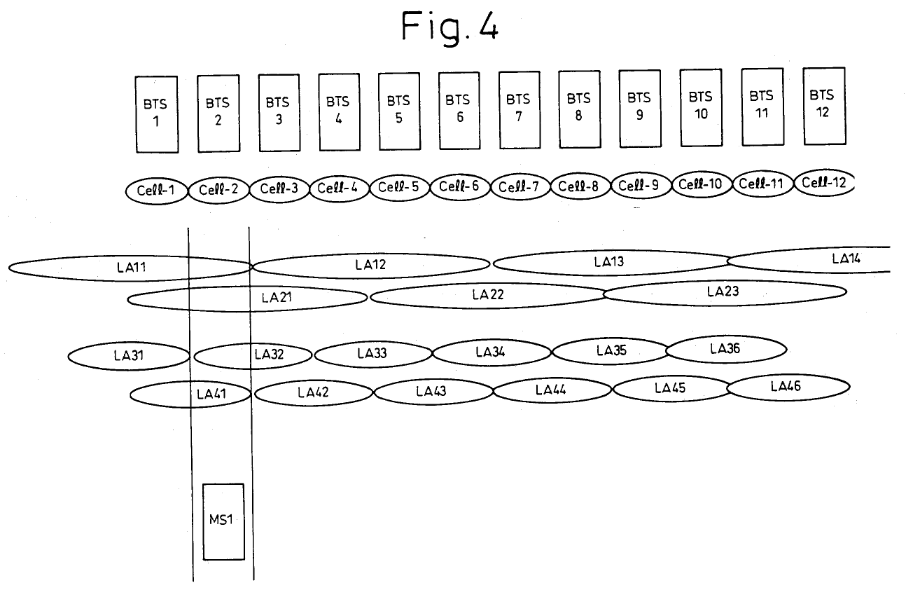

FIG. 4 shows an example of the simplest location registration area configuration. In FIG. 4, the location registration areas are designated by LAxx. Each location registration area is made up of one or more cells. The location registration areas are arranged in a plurality of layers. In the example shown here, the location registration areas are arranged in two layers. The first layer is labeled LA1x, and the second layer LA2x. Each base station BTSX has a broadcast information channel for broadcasting information to all the mobile stations served by the base station, and location registration area information is contained in the broadcast information. In FIG. 4, the base station BTS2 is transmitting broadcast information containing LA21 and LA11. When powered on, a mobile unit MS1 located in the area served by the base station BTS2 selects one LA contained in the broadcast information and registers its location in the selected LA. Suppose here that the location of MS1 is registered in LA21. In this case, the mobile unit periodically performs a location registration as long as it is receiving the broadcast information containing LA21. When the mobile unit has moved rightward in FIG. 4 from the area served by BTS4 to the area served by BTS5, the mobile unit also performs a location registration. In this case, the mobile unit registers its location in the location registration area (LA12) that belongs to the layer different from the layer where it was last registered. Registering the location in the different layer here is a technique employed to prevent the mobile unit from changing its location registration frequently when it is located near the border between different location registration areas.

The location registration area changing unit 64 makes the location registration area size smaller; this means that the location registration area configuration made up of LA1x and LA2x is changed to a configuration made up of smaller location registration areas LA3x and LA4x.

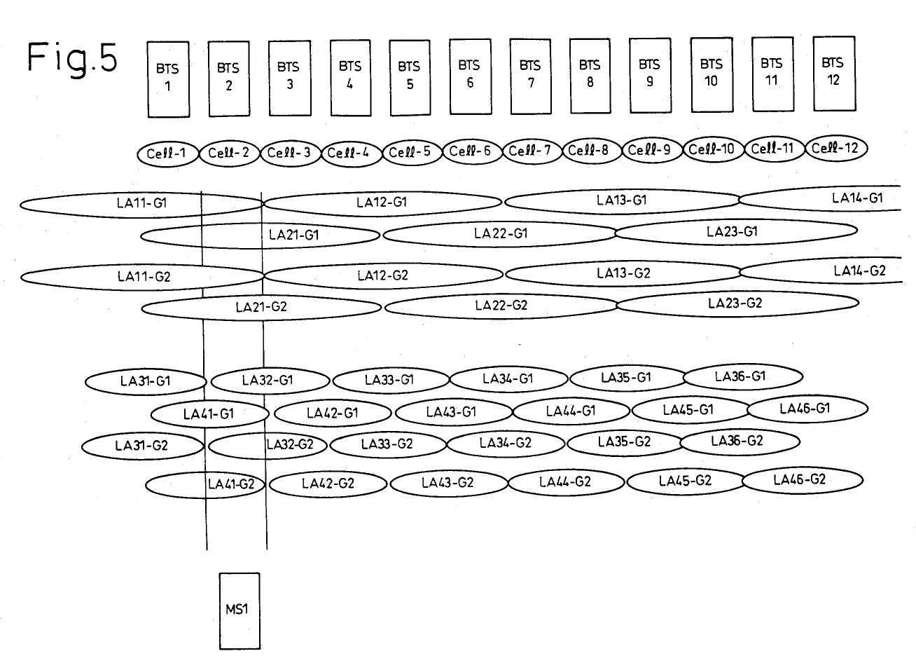

A location registration group-by-group area changing unit 66 changes the location registration area size for each predetermined group of mobile units. Mobile units are divided in advance between a plurality of groups, and the location registration areas are formed for the respective groups. FIG. 5 shows the location registration area configuration when the mobile units are divided into two groups G1 and G2. In FIG. 5, LAxx-G1 represents the location registration areas for the mobile units of group G1, and LAxx-G2 the location registration areas for the mobile units of group G2. The reason that the mobile units are divided between groups, and that the location registration areas are formed for the respective groups, is to prevent location registrations from occurring simultaneously at the same point in a mass transit vehicle, such as a train, and location registration traffic from concentrating in one particular area. Utilizing such grouping, the location registration group-by-group area changing unit 66 alleviates the concentration of location registration traffic by reducing the location registration area size for the respective groups in turn, for example, by reducing the location registration area size for the group G1 and, after a predetermined period of time, reducing the location registration area size for the group G2.

In order to avoid an increase in location registration traffic due to the reduced location registration area size, a terminal-by-terminal location registration area changing unit 68 changes the location registration area size reduced by the location registration group-by-group area changing unit 66 back to its original size for the mobile unit for which the change of the location has been detected by the location changing mobile unit information detecting unit 36.

An intra-area terminal determining unit 70 determines whether the mobile unit is located in the service providing area. An information line connecting unit 72 connects a user to the information providing unit 24 when the user accesses a mobile unit located in the service providing area. A connection holding unit 74 alleviates traffic concentration by querying the user, after connecting to the information providing unit 24, whether he wants the call to be connected to the called mobile unit if the line can get through to the called terminal. A location management unit 76 performs mobile location management and updating and, when the location registration area is changed to another area, notifies the user event detecting unit 18 accordingly. A personal user management unit 78 reports the newly user-registered terminal number to the personal user registration detecting unit 42 when the personal user has performed an operation to change the user registration from one terminal to another terminal. A service start/stop instructing unit 80 notifies the start of the service to the mobile switching equipment whose serving area is included in the service providing area determined by the area designating unit 34. A call control unit 82 performs call control such as call initiation, call answering, voice communication, and call clearing.

Next, a description will be given of how the functional blocks described above collaborate to provide information concerning the action of the user of the mobile unit located in the designated area.

The area designating unit 34 is activated under instruction from the event detecting unit 26 or the operator input unit 28, and determines the area (base station cell information, etc.) for the information providing service. The trigger detecting unit 32 is activated under instruction from the event detecting unit 26 or the operator input unit 28, and directs the service start/stop instructing unit 80 to start the service. The service start/stop instructing unit 80 notifies the service providing area information (cell information) and the start of the service to all the switching equipment whose serving areas are included in the area designated by the area designating unit 34. The call control unit 82 notified of the start of the service monitors the designated area for all kinds of events (mobile unit location change within the designated area, call initiation from mobile units, voice communication, etc.) occurring in that area. Upon detecting an event related to a mobile unit located within the designated area, the call control unit 82 reports the detected event to the user event detecting unit 18. When an event resulting from user action or operation (an event that satisfies a prescribed condition) is detected, the user event detecting unit 18 sends an event notification to the user event storing unit 22 via the user event transmitting unit 20 and the user event receiving unit 21. The user event storing unit 22 stores the received event and the number of the mobile unit (in the case of personal communication, the personal number). When there is an access to the mobile unit (the called mobile unit) from another terminal (the accessing terminal), the information line connecting unit 72 connects the accessing terminal to the information providing unit 24, and notifies the number of the called mobile unit to the information providing unit 24. Based on the received mobile unit number, the information providing unit 24 searches the user event storing unit 22 and, if information concerning that mobile unit is found, creates information based on the stored information and provides the information to the accessing terminal. In this way, an event resulting from user action or operation can be provided to a third party.

When the mobile unit crosses the border of the area served by the current base station and moves into a new location registration area, the mobile unit registers its location with the mobile communication network. The location information of the mobile unit is managed by the location management unit 76. The location management unit 76 reports the change of the location of the mobile unit to the location changing mobile unit information detecting unit 36, while also transferring thereto the received cell information together with the number of the mobile unit and the location registration signal. The location changing mobile unit information detecting unit 36 checks the received cell information to see if the cell matches any one of the cells included in the area designated by the area designating unit 34; if the cell matches one included in the designated area, the location changing mobile unit information detecting unit 36 reports the change of the location of the mobile unit to the location changing mobile unit information storing unit 46 via the user event transmitting unit 20 and the user event receiving unit 21. The location changing mobile unit information storing unit 46 stores the received mobile unit number and the fact that the location has changed. In this way, the user action (the fact that the user carrying the mobile unit has moved from one area to another) can be stored in the location changing mobile unit information storing unit 46.

When a call is initiated from a mobile unit, the call control unit 82 detects the call initiated by the mobile unit and performs a connection procedure. The call control unit 82, upon detecting the call from the mobile unit, transfers the number of the mobile unit and the cell information to the call initiating mobile unit information detecting unit 38.

The call initiating mobile unit information detecting unit 38 checks the received cell information to see if the cell matches any one of the cells included in the area designated by the area designating unit 34; if the cell matches one included in the designated area, the call initiating mobile unit information detecting unit 38 notifies the call initiating mobile unit information storing unit 48, via the user event transmitting unit 20 and the user event receiving unit 21, that the mobile unit has initiated a call. The call initiating mobile unit information storing unit 48 stores the received mobile unit number and the fact that the mobile unit has initiated a call. In this way, the user action (performed to initiate a call from the mobile unit) can be stored in the call initiating mobile unit information storing unit 48.

The call control unit 82 performs a series of call control procedures from the call initiation/call answering to call clearing. When the call is cleared, the call control unit 82 reports the number of the mobile unit, the cell information, and the duration of call to the voice communicating mobile unit information detecting unit 40. If the cell matches one included in the designated area, and if the duration of the call is longer than the predetermined length of time, the voice communicating mobile unit information detecting unit 40 notifies the voice communicating mobile unit information storing unit 50, via the user event transmitting unit 20 and the user event receiving unit 21, that the mobile unit has been operated for voice communication. The voice communicating mobile unit information storing unit 50 stores the received mobile unit number and the fact that the mobile unit has been operated for voice communication. In this way, the user action (the fact that the user performed a voice communication using the mobile unit) can be stored in the voice communicating mobile unit information storing unit 50.

The condition that the duration of the call must be longer than the predetermined length of time is provided so that the automatic answering made by an answering machine function to an incoming call to the mobile unit will not be erroneously detected as an event indicating the action of the mobile user; by setting the condition as described above, only a voice communication that lasted for more than the usual automatic answering time can be regarded as the voice communication actually performed by the user. This serves to enhance the reliability of safety information.

When the personal user changes the user registration from one terminal to another (for example, by removing the personal card from one terminal and inserting it into another terminal), the number of the newly user-registered terminal is reported to the personal user management unit 78. If the newly user-registered terminal is a mobile unit, the personal user management unit 78 reports the number of the mobile unit, the cell information, and the duration of call to the personal user registration detecting unit 42. If the reported cell matches one included in the designated area, the personal user registration detecting unit 42 notifies the personal user registration storing unit 52, via the user event transmitting unit 20 and the user event receiving unit 21, that the personal user has performed a new user registration. The personal user registration storing unit 52 stores the received personal number and the fact that the personal number is user registered. In this way, the user action (the fact that the user has changed his terminal) can be stored in the personal user registration storing unit 52.

When a data communication call is initiated from a mobile unit, the call control unit 82 detects the data communication call initiated by the mobile unit and performs a data communication connection procedure. The call control unit 82, upon detecting the data communication from the mobile unit, transfers the number of the mobile unit and the cell information to the data communicating mobile unit information detecting unit 44.

The data communicating mobile unit information detecting unit 44 checks the received cell information to see if the cell matches any one of the cells included in the area designated by the area designating unit 34; if the cell matches one included in the designated area, the data communicating mobile unit information detecting unit 44 notifies the data communicating mobile unit information storing unit 54, via the user event transmitting unit 20 and the user event receiving unit 21, that the mobile unit has performed a data communication. The data communicating mobile unit information storing unit 54 stores the received mobile unit number and the fact that the mobile unit has performed a data communication. In this way, the user action (the fact that the user performed a data communication using the mobile unit) can be stored in the user event storing unit 22.

The operator using the operator input unit 28 designates the area on a cell basis, and directs the initiation of the service. The operator input unit 28, in response to the instructions from the operator, reports the designated area to the area designating unit 34 and notifies the trigger detecting unit 32 of the occurrence of an event. After that, the service start/stop instructing unit 80 instructs the information providing unit 24 and the mobile switching equipment 12 to start the information providing service. In this way, the service can be started under instruction from the operator.

The event detecting unit 26 automatically detects the occurrence of a prespecified event such as an earthquake. The event detecting unit 26 reports the occurrence of the event to the trigger detecting unit 32 and the area designating unit 34 in the information providing apparatus 16. The area designating unit 34 determines the service providing area based on prespecified mapping information (information concerning the mapping of the event detecting unit 26 and the base stations). The trigger detecting unit 32 refers to the service providing area determined by the area designating unit 34 and, via the service start/stop instructing unit 80, instructs the information providing unit 24 and the mobile switching equipment 12 to start the service providing service. In this way, the service can be started automatically.

Immediately after the service is started, the location registration area changing unit 64 reduces the size of each of the location registration areas included in the area designated by the area designating unit 34, and thus makes the size smaller than the normal location registration area size. With each location registration area thus reduced in size, broadcast information carrying a new location registration area identifier is transmitted from each base station to all the mobile units served by the base station. As the location registration area identifier used for the last location registration is not found in the broadcast information, each mobile unit that received the broadcast information performs a location registration using the new location registration area identifier. After that, as the mobile unit is now registered in a new (smaller) location registration area, the location registration changes with a smaller distance of movement, and the mobile unit location change detection rate can thus be increased.

The location registration group-by-group area changing unit 66 changes the location registration area size in turn for the respective location registration groups of mobile units, thereby alleviating traffic concentration due to location registrations arising simultaneously from all the mobile units.

After the location registration area size is made smaller than its normal size by the location registration area changing unit 64 or the location registration group-by-group area changing unit 66, when a change in the mobile unit location is detected by the location changing mobile unit information detecting unit 36, the terminal-by-terminal location registration area changing unit 68 changes the location registration area size back to the normal size to reduce the location registration traffic thereafter. This serves to avoid traffic concentration due to location registrations.

There may be a situation where a call is made to a mobile unit located in the area served by a mobile switching center. There are two cases, a case in which the call is made from a mobile unit (the accessing terminal) located in the serving area of the same mobile switching center that is serving the called mobile unit, and a case in which the call to be connected to the called mobile unit is transferred from another mobile. switching center via a trunk line. When there is a call to the called mobile unit, the mobile switching equipment first analyzes the number of the called mobile unit, determines the HLR (Home Location Register) for the called mobile unit, and queries the HLR for the location of the mobile unit. Next, the location of the called mobile unit is determined, and a resource (radio link, trunk line, etc.) for paging the called mobile unit is seized. If the seizure of the resource failed (busy tone is detected), then the intra-area terminal determining unit 70 determines whether the called terminal is located in the designated service area. To acquire information for this determination, the intra-area terminal determining unit 70 may query the user event storing unit 22. If it is determined by the intra-area terminal determining unit 70 that the called terminal is located in the designated service area, the information line connecting unit 72 connects the line to the information providing unit 24.

In this way, when the connection cannot be established to the called terminal because of the failure of the resource seizure due to a radio link busy or trunk line busy condition, information related to the called terminal user can be provided to the accessing terminal from the information providing unit 24 nearest to the switching center.

Alternatively, when a call is made from a mobile unit (the accessing terminal) located in the area served by the mobile switching center to another mobile unit (the called mobile unit) located in the same area, or when there is an incoming call to the called mobile terminal via a trunk line, the intra-area terminal determining unit 70 determines whether the called mobile unit is located in the service providing area and, if it is located in the area, the connection holding unit 74 first connects the accessing terminal to the information providing unit 24, regardless of whether the line to the called terminal is available or not, and provides the information based on the information stored in the user event storing unit 22. After that, if the line can be connected to the called terminal, the accessing user is prompted to make a decision as to whether the call should be connected to the called terminal. On the other hand, if it is determined by the intra-area terminal determining unit 70 that the called mobile unit is not located in the service providing area, the usual call connection procedure is performed.

In this way, as the accessing user who was able to acquire the information related to the called mobile unit need not be connected to the called mobile unit, traffic concentration can be alleviated.

For a user who accessed from a voice terminal such as a telephone, if a user event is stored in the user event storing unit 22, the voice information providing unit 56 generates voice announcement information based on the information stored in the user event storing unit 22, and produces the voice announcement. In this way, information related to the called terminal can be provided to a voice terminal.

The content information providing unit 58 provides content to a user who accessed via a data network such as the Internet; by so doing, the information can also be provided in response to an access from a personal computer or like terminal.

The information providing permitting unit 60 stores information concerning access restrictions. The information includes, for example, an accessing terminal's originator number, a preassigned password, etc. When there is an access to the information providing unit 24 from an accessing terminal, the information providing permitting unit 60 checks the information of the accessing terminal (originator number and password) to determine whether they match the preregistered ones. If it is determined that the access is permitted, information is provided in the form that matches the type of the accessing terminal. If the access is not permitted, information is not provided. In this way, the recipient of the user information can be restricted to preregistered recipients only.

The recipient list storing unit 61 stores a list of recipients specified by the user. After the information providing service is activated, if a user event change is detected by the user event detecting unit 18, the event is reported to the user event storing unit 22 via the user event transmitting unit 20 and the user event receiving unit 21. The user event storing unit 22 notifies the automatic information providing unit 62 of the detection of the event. The automatic information providing unit 62 searches the recipient list storing unit 61 for information corresponding to the mobile unit and, if the information related to the mobile unit is found, creates information in the form that matches the type of each destination (telephone, electronic mail, etc.) and transmits out the information.

In this way, safety information can be automatically delivered to the prespecified recipients (families, relatives, etc.) in the event of an emergency such as a disaster.

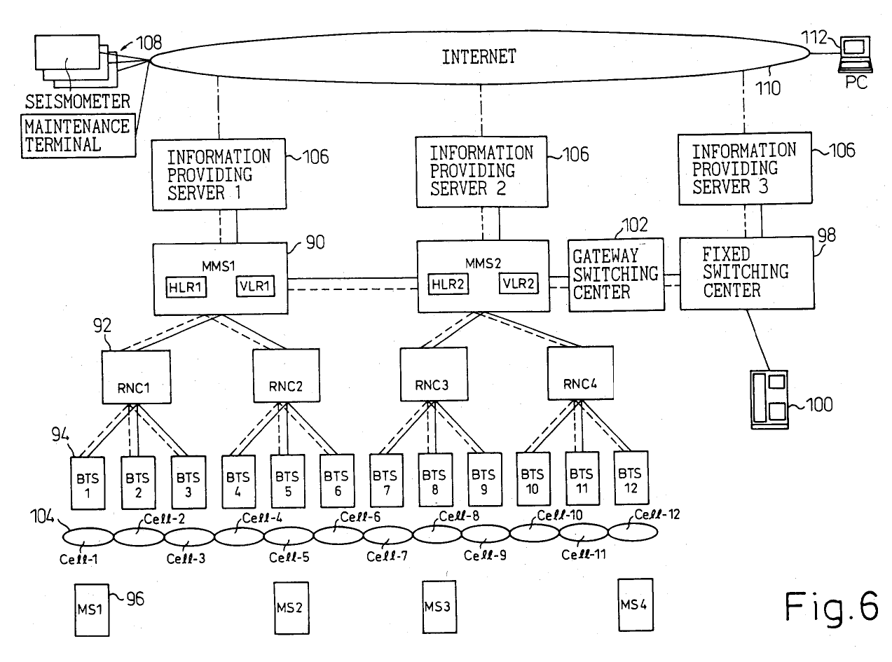

The network configuration for the information providing system of the present invention is shown in FIG. 6.

A mobile switching network comprises mobile switching centers 90 (MMS), base station controllers 92 (RNC), base stations 94 (BTS), and mobile units 96 (MS). The mobile switching centers 90 perform switching control for mobile communications by controlling the respective base station controllers 92, base stations 94, and mobile units 96. A fixed switching center 98 is a switching center serving fixed terminals 100, and is connected to the mobile network via a gateway switching center 102. Each base station controller 92 controls a plurality of base stations 94, and relays signals to and from the base stations 94. An area within which radio waves transmitted from one base station 94 can be received is called a cell 104, and each base station 94 manages the mobile units 96 on a cell basis.

In FIG. 6, solid lines show communication lines used for transmission of user information such as voice and data. Dashes lines indicate control lines.

Information providing servers 106 are connected to the respective mobile switching centers 90 and the fixed switching center 98. Each information providing server 106 comprises the trigger detecting unit 32, area designating unit 34, user event storing unit 22, information providing unit 24, service start/stop instructing unit 80, and user event receiving unit 21, which were explained with reference to FIG. 3. Each mobile switching center 90 comprises the user event detecting unit 18, user event transmitting unit 20, location management unit 76, personal user management unit 78, location registration area changing unit 64, location registration group-by-group area changing unit 66, terminal-by-terminal location registration area changing unit 68, intra-area terminal determining unit 70, information line connecting unit 72, connection holding unit 74, and call control unit 82, which were explained with reference to FIG. 2.

The information providing servers 106 operate in collaboration with measuring instructions for detecting events, such as a seismometer, seismic intensity meter, etc., and when any one of prespecified events is detected by these instruments, the detection of the event is reported to the respective information providing servers 106.

The information providing servers 106 are connected to the Internet so that information can also be provided via the Internet when an access is made to any one of the information providing servers 106 from a terminal 112 such as a personal computer.

Table 1 shows an example of information stored in the user event storing unit 22. When a user event is detected by the user event detecting unit 18, the mobile unit number/personal number, the detected event, and the date/time of event detection are stored in the user event storing unit 22 contained in the information providing server 106. When a plurality of events are detected from the same user, the respective events are stored together with date/time information. When the same event as that already stored is detected, the date/time of the event detection is stored in addition to the already stored information.

TABLE 1
EXAMPLE OF INFORMATION STORED IN USER EVENT
STORING UNIT 22

| MOBILE UNIT | | |
|---|---|---|
| NUMBER/PERSONAL | | DATE/TIME OF |
| NUMBER | EVENT DETECTED | EVENT DETECTION |
| 090-1234-5678 | LOCATION | 5/26 10:05 |
| | CHANGE | 5/26 11:15 |
| | | 5/26 11:30 |
| | CALL INITIATION | 5/26 11:12 |
| 090-1234-0001 | PERSONAL USER | 5/26 10:30 |
| | REGISTRATION | |
| 090-1234-0005 | VOICE | 5/26 10:33 |
| | COMMUNICATION | |
| | CALL INITIATION | 5/26 12:34 |
| 090-1234-0006 | DATA | 5/26 11:00 |
| | COMMUNICATION | |

Detection of an event and the initiation of the service will be explained by taking as an example the case where a seismic intensity meter is used as the event detecting unit 26.

The seismic intensity meter is set in advance so that an event occurrence notification will be transmitted to the information providing server 106 when an earthquake whose seismic intensity is greater than 6 is detected.

The seismic intensity meter automatically measures the intensity of an earthquake and, if the measured value exceeds a seismic intensity of 6, reports the occurrence of the event and the location of the reporting seismic intensity meter to its collaborating information providing server 106. The information providing server 106 is provided with a trigger detection device for receiving an event occurrence notification and the location information of the seismic intensity meter, and can thus receive the event occurrence notification and the location information of the reporting seismic intensity meter.

When event occurrence notifications are received from a plurality of seismic intensity meters located in various regions, the information providing server 106 determines the service providing area on a cell basis by comparing the mapping information of the reporting seismic intensity meters with that of the cells.

After determining the service providing area, the information providing server 106 specifies service activation information and the area as shown in Table 2, and notifies the corresponding mobile switching center 90 of the initiation of the service. The service activation information indicates the service activation state, i.e., the service not activated, the service activated in the current switching center, and the service activated in another switching center. The “service not activated” state indicates the normal operating state, that is, the state in which the information providing service is not activated. The “service activated in current switching center” state indicates that the base stations served by the current switching center are designated as the service providing area. The “service activated in another switching center” state indicates that the base stations served by the current switching center are not designated as the area to be monitored, but that the service is activated in a neighboring switching center (or a switching center that can affect the current switching center).

The mobile switching center notified of the initiation of the service with the “service activated in current switching center” state registers the service activation information and the designated area on a cell basis in the table, and sets the service in the activated state. Table 2 shows an example of the service activation information and designated area information.

TABLE 2
SERVICE ACTIVATION INFORMATION AND DESIGNATED
AREA INFORMATION

| | |
|---|---|
| SERVICE ACTIVATION | 1 |
| INFORMATION | |
| DESIGNATED AREA | CELL 6 |
| | CELL 7 |
| | CELL 8 |
| | CELL 9 |
| | CELL 10 |
| | CELL 11 |
| | CELL 12 |
| | CELL 13 |
| | CELL 14 |

SERVICE ACTIVATION INFORMATION
0: SERVICE NOT ACTIVATED
1: SERVICE ACTIVATED IN CURRENT SWITCHING CENTER
2: SERVICE ACTIVATED IN ANOTHER SWITCHING CENTER

The mobile switching center notified of the initiation of the service with the “service activated in another switching center” state registers the service activation information in the table. In this case, the designated area information is not stored.

The initiation of the service can also be directed by the operator attending the information providing server 106. The operator notifies the information providing server 106 of the occurrence of an event. The information providing server 106 is provided with a trigger detection device for receiving an event occurrence notification, and recognizes that the notification is one originating from the operator. The service providing area in this case is designated on a cell basis at the discretion of the operator or based on predetermined criteria.

The method of service activation notification to each switching center is the same as that for the case of the automatic service activation performed based on a seismic intensity meter.

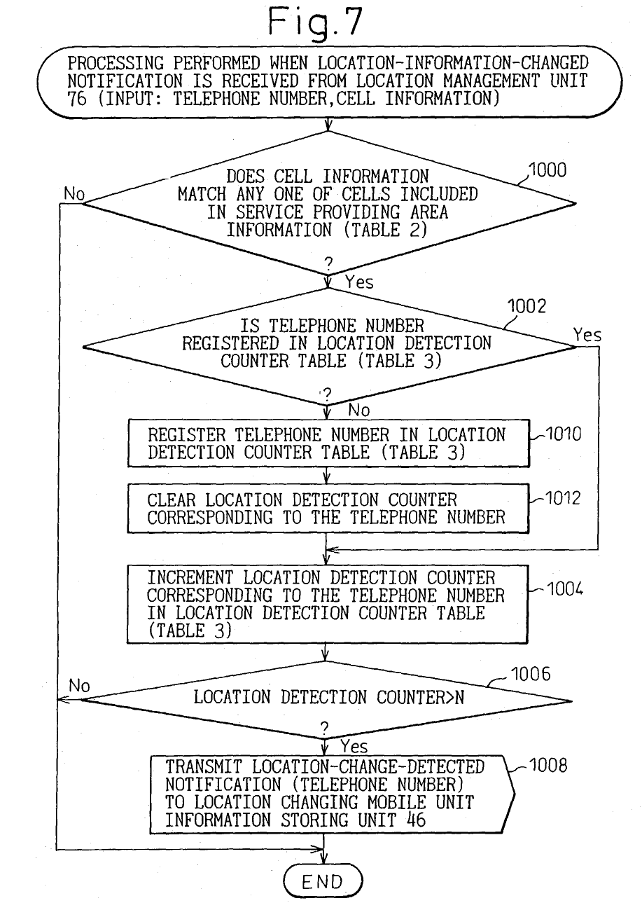

FIG. 7 is a process flow for the location changing mobile unit information detecting unit 36. when the mobile unit registers its location, the location management unit 76 checks whether the location registration area is changed or not and, if it is changed, sends a location-information-changed notification to the user event detecting unit 18. The location-information-changed notification contains the number of the mobile unit and information indicating the cell where the mobile unit is located. The location changing mobile unit information detecting unit 36 extracts the number of the mobile unit and the cell information from the location-information-changed notification, and checks the cell information to see if the cell matches any one of the cells included in the service providing area information (Table 2) (step 1000). If the cell indicated by the cell information matches one included in the service providing area, a location detection counter table (Table 3) is searched on the mobile unit number to see whether the number of the mobile unit is registered in the table (step 1002). If the number of the mobile unit is already registered, its corresponding location change detection counter in the table is incremented (step 1004). If the counter value exceeds a predetermined threshold (step 1006), the location-changed notification is transmitted to the location changing mobile unit information storing unit 46 (step 1008). If the number of the mobile unit is not registered yet, the number of the mobile unit is newly registered (step 1010), and the location change detection counter is cleared to 0 (step 1012).

TABLE 3
LOCATION DETECTION COUNTER TABLE IN LOCATION
CHANGING MOBILE UNIT INFORMATION DETECTING
UNIT 36

| MOBILE UNIT | LOCATION CHANGE | |
|---|---|---|
| NUMBER | DETECTION COUNTER | THRESHOLD (N) |
| 090-1234-5678 | 2 | 3 |
| 090-1234-0001 | 3 | 3 |
| 090-1234-0005 | 1 | 3 |
| 090-1234-0006 | 1 | 3 |

It is desirable that the threshold (N) for the location detection counter be set larger than 2. The reason is as follows.

When the location of the mobile unit is registered based on the normal location registration area configuration in FIG. 4 (here, a two-layer configuration is assumed), and when the mobile unit is located at the border between different location registration areas (for example, the mobile unit is registered its location in LA21 and is located near the border between Cell-4 and Cell-5), then even if the mobile unit is stationary, a location registration may occur and the mobile unit may be registered in LA12, depending on the fluctuations of radio wave signals. Since such a location registration is not an event occurring due to the movement of the mobile user himself, it is not suitable as the information to be used to verify the user's safety. Once the location registration is done in LA12, the mobile unit does not register its location once again as long as it is located within the area of LA12 (which covers the areas served by BTSs 3, 4, 5, and 6), and the next location registration should occur when the mobile unit moves into another location registration area. Therefore, the second location registration is an event that indicates that the mobile unit has undoubtedly moved.

FIG. 8 is a process flow for the call initiating mobile unit information detecting unit 38. When the mobile unit initiates a call, the call control unit 82 sends a call-initiation-detected notification to the user event detecting unit 18. The call-initiation-detected notification contains the number of the mobile unit and the cell information at the time of call initiation. The call initiating mobile unit information detecting unit 38 checks the cell information to see if the cell matches any one of the cells included in the service providing area information (Table 2) (step 1100). If the mobile unit is determined as being within the service providing area, the call-initiation-detected notification is transmitted to the call initiating mobile unit information storing unit 48 (step 1102).

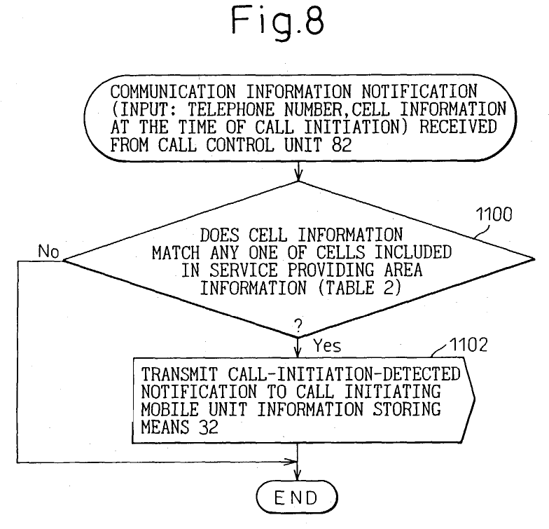

FIG. 9 is a process flow for the voice communicating mobile unit information detecting unit 40. When the mobile unit performs a voice communication for more than a predetermined length of time (the threshold for call duration is set using a maintenance terminal or the like and stored in the voice communicating mobile unit information detecting unit 40), the call control unit 82 sends a communication information notification to the user event detecting unit 18. The communication information notification contains the number of the mobile unit, the cell information at the time of call termination, and the duration of the call. The voice communicating mobile unit information detecting unit 40 checks the cell information to see if the cell matches any one of the cells included in the service providing area information (Table 2) (step 1200). If the mobile unit is determined as being within the service providing area, then it is determined whether the duration of the call is longer than the preset value (step 1202) and, if it is longer than the preset value, a voice-communication-detected notification is transmitted to the voice communicating mobile unit information storing unit 50 (step 1204). Here, the preset call duration value is set longer than the maximum communication time allowed for the automatic answering that the answering machine function of the mobile unit makes to an incoming call to the mobile unit.

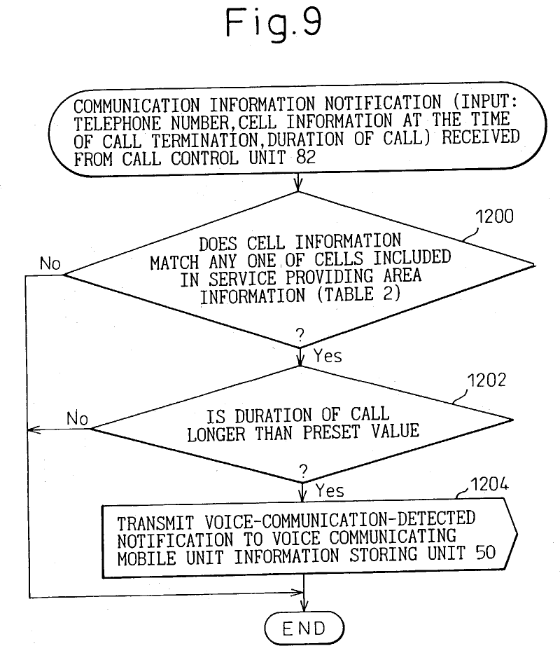

FIG. 10 is a process flow for the personal user registration detecting unit 42. The personal user management unit 78 stores the personal number assigned to each user and the number of the terminal currently registered for the personal number. Table 4 shows an example of data managed in the personal user management unit 78. The types of terminals registered here include mobile terminal, fixed terminal, etc. and the user can make and receive calls by using any desired terminal.

TABLE 4
EXAMPLE OF INFORMATION MANAGED IN PERSONAL USER
MANAGEMENT UNIT 78

| PERSONAL NUMBER | USER REGISTERED NUMBER |
|---|---|
| P000000001 | 090-1234-5678 |
| P000000002 | 092-852-3211 |
| P000000003 | 044-777-1111 |
| P000000004 | NOT REGISTERED |
| P000000005 | 092-852-3212 |
| P000000006 | 044-777-1112 |
| P000000007 | NOT REGISTERED |

When the personal card with the personal number recorded thereon is inserted into the desired terminal, the user can use the terminal as his own terminal. The following description assumes that the terminal into which the personal card is inserted is a mobile terminal. When the personal card is inserted into the terminal, a personal user registration message (containing the personal number, mobile unit number, and cell information) is transmitted from that terminal to the mobile switching center via the base station and the base station controller. At the mobile switching-center, the user registered number for that user, managed in the personal user management unit 78 shown in Table 4, is updated to the newly reported mobile unit number, and a notification is sent to the personal user registration detecting unit 42. The personal user registration detecting unit 42 checks the cell information contained in the notification to see if the cell matches any one of the cells included in the designated area shown in Table 2 (step 1300) and, if it matches, transmits the notification to the user event storing unit 22 via the user event transmitting unit 20 and the user event receiving unit 21 (step 1302). The user event storing unit 22 checks the personal number to see if it is registered in Table 1 and, if it is already registered, then stores the detected event (personal user registration) and the time of detection in association with the corresponding personal number. If the personal number is not registered in Table 1 of the user event storing unit 22, the personal number is added in the table, and the detected event (personal user registration) and the time of detection are stored.

When the location registration area changing unit 64 is activated at the start of the service, the location registration area changing unit 64 makes the location registration areas in the designated area smaller than the normal location registration area size (see FIG. 4). More specifically, the location registration area size is reduced in the following procedure. It is assumed that location registration has been done with the normal location registration areas (L1x, L2x). At this time, each base station is transmitting, as its cell broadcast information, location information covering all the location registration areas in which the serving area of the base station is included. For example, BTS2 is transmitting LA11 and LA21 as the location information. The location of MS1 is already registered in LA11 or LA21, and the location registration area where it is registered is stored in MS1. Suppose here that MS1 is registered in LA21; then, if MS1 moves into the area served by BTS5, MS1 performs a location registration as the location information stored in MS1 is not found in the broadcast information it receives. When the location registration area changing unit 64 is activated, the location registration areas change to the location registration areas made up of LA3x and LA4x, and the location information broadcast from each base station also changes to the location information covering LA3x and LA4x. MS1 being served by BTS2 needs to perform a location registration because the location information it is receiving changes from LA11, LA21 to LA32, LA41. In this case, the location registration is done in either one of the location registration areas, LA32 or LA41. When the location of MS1 is registered in LA32, and MS1 is located near the border between Cell-2 and Cell-1, a location registration may occur in LA41 if the broadcast information from the BTS1 becomes stronger due to fluctuations of radio wave signals. Therefore, when the location registration area size is changed by the location registration area changing unit 64, it is desirable that the threshold N for the location registration detection counter be set to 3.

When the location registration area size is changed immediately after the start of the service, the amount of traffic will increase suddenly due to location registration updates as the mobile units located in the designated area simultaneously attempt to update their location registrations. To avoid the increase in traffic due to such simultaneous location registration updates, the location registration area size is changed in steps by utilizing the previously described mobile unit grouping. Consider the case where the location registration areas are arranged into a plurality of groups, as shown in FIG. 5. LAxx-G1 designates the location registration areas of group 1, and LAxx-G2 the location registration areas of group 2. Each mobile unit is set up in advance to belong to one of the groups. It is assumed here that MS1 belongs to group 1. MS1 is receiving broadcast information from BTS2, and the broadcast information covers the location registration areas of group 1 (LA11-G1 and LA21-G1) and group 2 (LA11-G2 and LA21-G2). The mobile unit MS1 monitors only the location registration areas of the group (group 1) to which it belongs, and checks to see if the location registration area (in the illustrated example, LA21-G1) where it is registered is included in the information. The location registration group-by-group area changing unit 66 changes the location registration area size on a group-by-group basis. The location registration group-by-group area changing unit 66 first changes the location registration area size for the mobile units assigned to group 1. More specifically, in FIG. 5, the location registration areas LA1x-G1 and LA2x-G1 are changed to the location registration areas LA3x-G1 and LA4x-G1. As a result, in the location information to be broadcast from each base station, the portion corresponding to group 1 is changed to reflect the values of the new location registration areas. That is, the information broadcast from BTS2 now carries the values of the location registration areas LA32-G1, LA41-G1, LA11-G2, and LA21-G2. The mobile unit MS1 located in the area served by BTS2 compares the location information (LA21-G1) stored in MS1 with the location information of group 1 contained in the broadcast information; since the location information stored in it is not found in the broadcast information, MS1 registers its location with a new location registration area (LA32-G1 or LA41-G1). When the location registration areas for group 1 are being changed, the mobile units belonging to the other groups do not perform location registrations.

When the traffic due to the location registrations for group 1 has settled down to a certain level, the location registrations for group 2 are changed. When the traffic due to the location registrations for group 2 has settled down to a certain level, the location registrations for group 3 are changed. In this case, it is desirable that the threshold N for the location change detection counter be set larger than 3.

By changing the location registration areas on a group-by-group basis, as described above, traffic concentration due to location registrations can be avoided.

After the location registration area size is made smaller than the normal size by the location registration area changing unit 64 or the location registration group-by-group area changing unit 66, when a change in the mobile unit location is detected by the location changing mobile unit information detecting unit 36, the terminal-by-terminal location registration area changing unit 68 changes the location registration area size back to the normal size to reduce the location registration traffic thereafter.

The broadcast location information is classified between the wider location registration areas used in the normal operation and the narrower location registration areas used in an emergency situation (EM). In the normal operating state, the broadcast information contains only the normal location registration areas. When the information providing service is activated, the emergency location registration areas are added in the broadcast information. The additional information also includes a counter M for specifying the number of location registrations in the emergency mode. When the broadcast information in which the emergency location registration areas are added is received for the first time, the mobile unit MS1 registers its location in one of the emergency location registration areas, and thereafter performs a location registration in the emergency (EM) mode. During the first location registration, the counter M is stored in the mobile unit. The mobile unit MS1 is counting the number of location registrations and, when the number of location registrations reaches the value preset by the counter M, the location registration area is changed back to the normal mode.

Here, it is desirable that the counter M be set equal to the location change detection counter N.

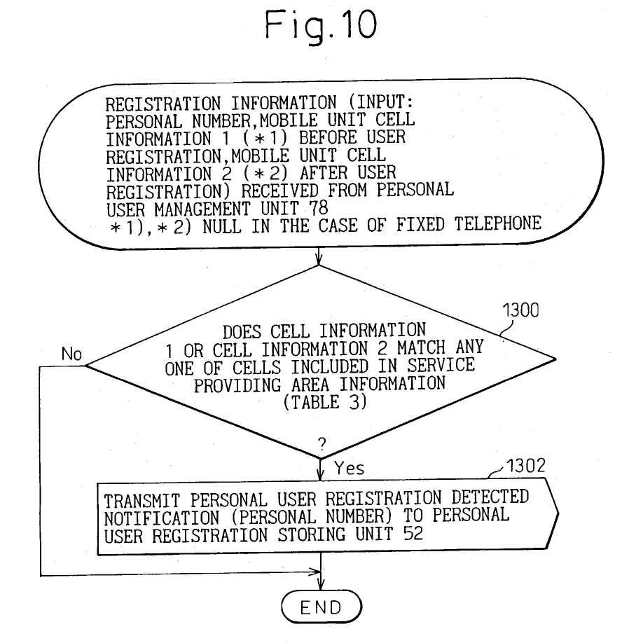

FIG. 11 is a flowchart illustrating the operation performed at the mobile switching center when a call arrives from a mobile unit.

When a call arrives at the mobile switching center from a mobile unit located in its serving area, HLR is determined based on the called telephone number (step 1400). A query is made to the HLR (step 1402); if the location information contains a pointer to VLR, a trunk line to the switching center nearest to the VLR is seized (step 1404). If the trunk line is busy, the service activation state is checked by referring to the service activation information (Table 2) stored within the switching center (step 1406); if the service activation information indicates the “service activated in current switching center” state or the “service activated in another switching center” state, i.e., the state in which the service is activated in a neighboring switching center, the call is connected to the information providing server (step 1408). If the service activation information indicates the “service not activated” state, as this means that the trunk line is just busy for some reason, a busy tone is transmitted to the accessing terminal (step 1410). If the trunk line is not busy, the call is transmitted onto the trunk line to the switching center nearest to the VLR (step 1412).

If the location information does not point to VLR, a radio link resource is seized (step 1414). If the resource is busy at this time, the service activation state is checked by referring to the service activation information (Table 2) stored within the switching center; if the service activation information indicates the “service activated in current switching center” state or the “service activated in another switching center” state, i.e., the state in which the service is activated in a neighboring switching center, the call is connected to the information providing server (step 1408). If the service activation information indicates the “service not activated” state, since this means that the trunk line is just busy, a busy tone is transmitted to the accessing terminal (step 1411).

If the trunk line is not busy, the usual call connection is possible, so that the called terminal is paged (step 1416).

When there is an access to a mobile unit located in the service providing area, the information providing server searches the user event storing unit 22 to see whether the number of the mobile unit is registered or not (see Table 1). If the requested mobile unit is found, a search is made through an information providing permission list (Table 5). If the user of the mobile unit restricts the recipient of the information to preregistered recipients, the number of the accessing terminal is searched for; if the number is registered in the list, the information is provided. If it is not registered in the list, a busy tone is transmitted to the accessing terminal.

TABLE 5
EXAMPLE OF INFORMATION STORED IN INFORMATION
PROVIDING PERMITTING UNIT 60

| MOBILE UNIT NUMBER/ | |
|---|---|
| PERSONAL NUMBER | PERMITTED NUMBER |
| 090-1234-5678 | 092-123-4567 |
| | 044-777-1234 |
| 090-1234-5679 | 044-777-1111 |
| 090-1234-0000 | NOT REGISTERED |

In the case where the connection holding unit 74 is used, if the line can be connected through, the accessing user is prompted to make a decision as to whether the call should be connected to the mobile unit.

In one example of the information providing method, if the user of the mobile unit has ever moved from one area to another, and if the information providing means is a voice message, then a voice message saying, for example, “The user of 090-1234-5678 has moved from one area to another” is transmitted.

If the user has ever made an emergency call such as 110 (Police) or 119 (Fire Station), this could mean that the user himself or someone around him has suffered an injury in the disaster.

In that case, information saying “The records show that the user of 090-1234-5678 made a call to 110 (or 119) at xxxx hours” can be transmitted to the calling person to inform him that the user or someone around the user may have suffered an injury.

However, as revealing such emergency information may affect the user's privacy, provisions may be made so that the user can enable or disable the setting for the transmission of such information.

The information providing server 106 is also connected to the Internet 110 so that the user event information can be provided via a web page when an access is made to the information providing server 106 from the terminal 112 such as a personal computer.

When the user of the mobile unit desires to restrict the recipient of the user event information, the recipient(s) to be allowed to receive the information is registered in advance, for example, when the user subscribes to the mobile telephone service. The registered information here is reflected in the list stored in the information providing permitting unit 60.

When there is an access to the mobile user in the event of an emergency, the information providing permitting unit 60 searches the information providing permission list (Table 5) to see if the mobile unit number/personal number of the called user is registered in the list. If the number is registered, then the number of the accessing party is checked. If the number of the accessing party is registered as a permitted number, and if any event related to the user is stored in the user event storing unit 22, the user information is provided.

Table 6 shows an example of the recipient list stored in the recipient list storing unit 61. When subscribing to the mobile telephone service, for example, the user of the mobile unit registers the recipient(s) to whom the user wants his state to be transmitted in the event of an emergency. The registered information here is reflected in the list stored in the recipient list storing unit 61 of the information providing server.

TABLE 6
EXAMPLE OF RECIPIENT LIST STORED IN RECIPIENT
LIST STORING UNIT 61

| MOBILE UNIT | | |
|---|---|---|
| NUMBER/PERSONAL | | RESULT OF |
| NUMBER | RECIPIENT LIST | TRANSMISSION |
| 090-1234-5678 | 092-123-4567 | TRANSMISSION |
| | | COMPLETED |
| | 044-777-1234 | TRANSMISSION |
| | | FAILED |
| | taro@fujitsu.co.jp | TRANSMISSION |
| | | COMPLETED |
| 090-1234-5679 | 044-777-1111 | |
| 090-1234-0000 | NOT REGISTERED | |

After the start of the service, a notification is sent to the information providing unit 24 at the same time that a user event is stored in the user event storing unit 22. The recipient list storing unit 61 checks the recipient list and, if the user of the mobile unit is registered in the list, transmits the user event via the information providing unit 24 to all the eligible recipients registered in the list. Table 6 shows an example of the recipient list stored in the recipient list storing unit 61. Telephone numbers and electronic mail addresses can be registered in the recipient list. When the user event is transmitted to each eligible recipient, the result of the transmission is recorded in the recipient list; if the transmission failed, a retransmission is tried after a predetermined period of time.

When the congestion of traffic in the mobile switching center is alleviated, the information providing service is stopped. The service stopping flow will be described below.

Using the maintenance terminal, the operator can see that the congestion in the switching center has settled down (known function). When the operator directs the stopping of the service by using the operator input unit 28, the operator input unit 28 issues a service stopping instruction to the trigger detecting unit 32. The trigger detecting unit 32 instructs the service start/stop instructing unit 80 to stop the service. The service start/stop instructing unit 80 also instructs the location registration area changing unit 64 and the user event detecting unit 18 to stop the service. The location registration area changing unit 64 that received the service stopping instruction from the service start/stop instructing unit 80 changes the location registration area size back to the normal size. The user event detecting unit 18 that received the service stopping instruction from the service start/stop instructing unit 80 sets the service activation information in the designated area table (Table 2) back to the “service not activated” state. With the above procedure, the service is stopped.

The above embodiment has been described by dealing with the case where the cell related to the event can be isolated to one single cell; however, in the case of CDMA systems which use a technique called Rake receiving, a plurality of cells (a maximum of four cells in the case of the IMT-200 W-CDMA system) performing Rake receiving are involved in the related cell information. Accordingly, when determining whether the area is included in the service area information (a set of cell information), if at least one of the cells involved in the Rake reception matches any one of the cells included in the area information, then it is determined that the area matches the area information; by making this provision, the same operation as described in the above embodiment is possible even in the case of CDMA.

Further, in the above embodiment, the area is designated on a cell basis, but alternatively, the area may be designated on a switching center basis. In that case, there is no need to extract the cell information when a user event is detected.

The example described above has employed the configuration in which information indicating the action of a mobile user, such as a change in the location of the mobile unit, a call initiation from the mobile unit, etc., is detected at the mobile switching center and transmitted to the information providing apparatus. In contrast, in the configuration described hereinafter, information indicating user action is detected at the mobile unit, and the detected information is transmitted via the mobile switching center to the information providing apparatus.

As will be described below, it is desirable that the location registration process be utilized when transmitting user action information from the mobile unit to the network. The reason is that when congestion occurs, outgoing call restrictions are imposed but, as processing of higher importance, such as location registration, is given higher priority, the action information can be transmitted without fail.

The action information detectable at the mobile unit includes, for example, the following events.

(1) The mobile unit has moved into the area (cell or sector) served by another base station. When the mobile unit is in the stand-by mode, from the network side it is possible to know in which location registration area the mobile unit is registered, but it is not possible to know which base station in that area is serving the mobile unit.

(2) The location of the mobile unit, detected by the GPS (Global Positioning System) incorporated in the mobile unit, has changed.

(3) A predetermined password is input to the mobile unit.

(4) An emergency message is input to the mobile unit. In this case, the emergency message is included in the location registration message.

When transmitting the action-information by making use of the location registration process, the information must be distinguished from the location registration message which is periodically transmitted in a conventional mobile communication system even when the mobile unit is staying in the same location registration area. To achieve this, when the location registration areas are organized in multiple layers, if the mobile unit is turned off and then on or a change occurs in the multi-layer location registration area combination (for example, LA11 and LA21) after receiving the service start notification from the base station in the designated area, then the location registration is forcefully changed to a different layer. More specifically, in FIG. 4, for example, when MS1 receiving the broadcast information covering LA11 and LA21 is registered in LA21, usually, the location registration area is not changed because of hysteresis as long as MS1 is receiving the broadcast information covering LA21; in contrast, in the present invention, when the mobile unit is turned off and then on or when information covering LA12 and LA21 is received, the location registration is changed to LA22. By so doing, at the network side the location registration message can be used as an action information carrying means, and can thus be distinguished from the periodic location registration message (which indicates that the location registration area is changed). However, if information indicating whether the message is the periodic message or not can be included in the location registration message, there is no need to transmit the location registration message by forcefully changing the location registration to a different layer as described above, but the location registration should be made by including therein information indicating the forceful location registration.

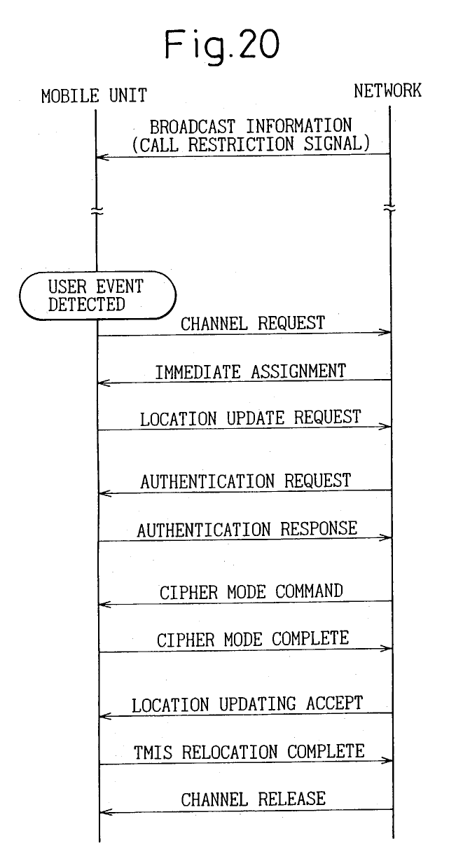

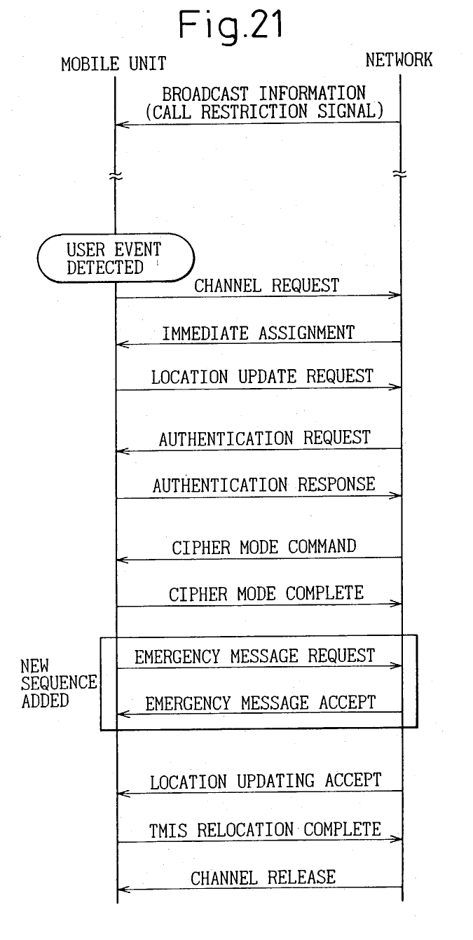

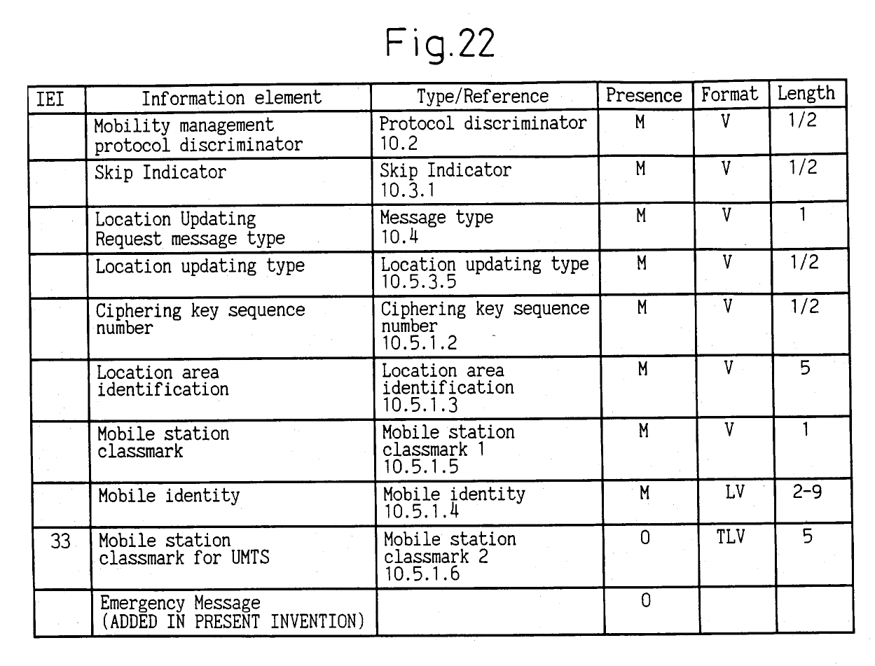

FIG. 20 shows one example of a location registration sequence for user event notification. If an emergency message is to be included in the user event notification, either an emergency message transmission sequence is added as shown in FIG. 21, or an information element of emergency message is added to the information element of the location registration message (LOCATION UPDATE REQUEST in FIG. 20) as shown in FIG. 22. Here, since the periodic location registration or not can be identified by the “Location updating type” in FIG. 22, if this identifier is used to distinguish, from the periodic location registration, the location registration for the transmission of the action information, there is no need to change the location registration to a different layer as described above.

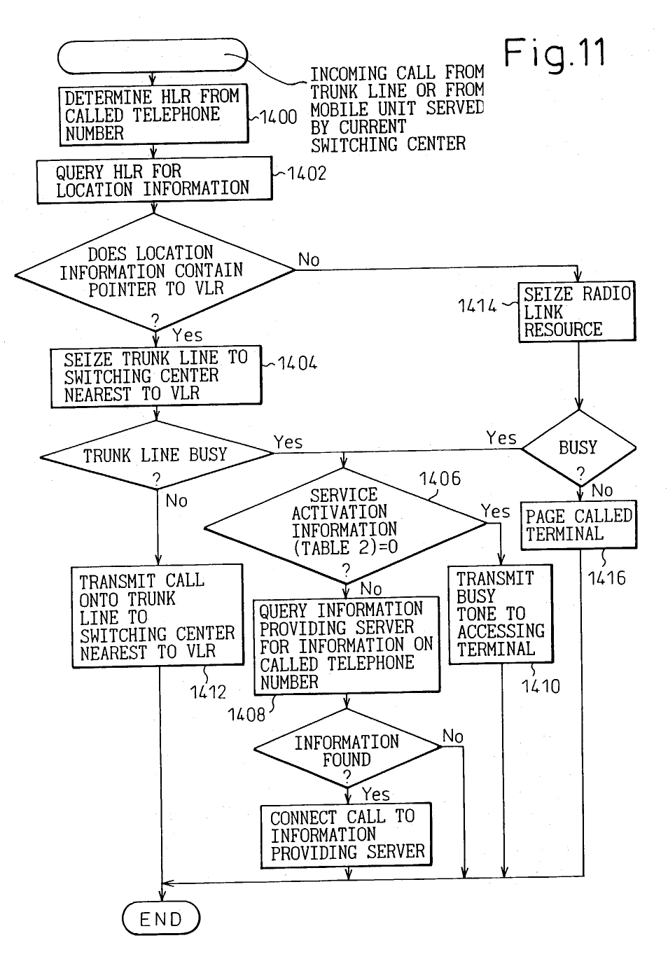

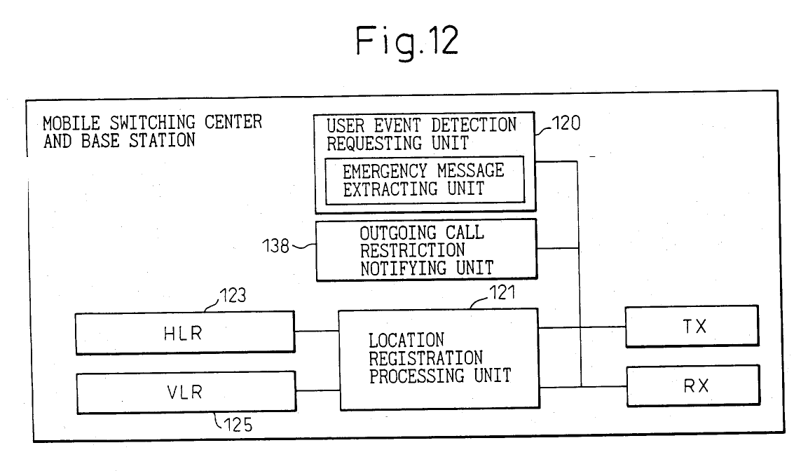

FIG. 12 shows the functional blocks to be provided in the mobile switching center 90 (FIG. 6) and the base station 94 in order to accomplish the detection and notification of the action information at the mobile unit as described above, and FIG. 13 shows the functional blocks to be provided in the mobile terminal 96.

A location registration processing unit 121 manages the location of each mobile unit by registering the location in a home location register (HLR) 123 or a visitor location register (VLR) 125.

A user event detection requesting unit 120 requests mobile terminals to start the detection of a user event. The detection request is broadcast to all the terminals from the respective base stations serving them. A user event detection accepting unit 122 in the mobile unit accepts the user event detection request broadcast via the network, to start the detection of a user event. A user event detecting unit 124 is activated when the user event detection request is accepted by the user event detection receiving unit 122, and starts to detect an event related to the user. A base station change detecting unit 126 detects whether the base station, cell, or sector is changed, from the time the user event detection was started. A GPS location change detecting unit 128 performs measurements using GPS when the user event detection request is accepted by the user event detection receiving unit 122, and thereafter performs the measurements using GPS at predetermined intervals of time; if a change in the location that satisfies a predetermined condition is detected, it is determined that a user event is detected. A password input detecting unit 130 detects a password input from the user after the user event detection request was accepted by the user event detection receiving unit 122, and determines that an user event is detected when authentication has been done successfully. An emergency message input unit 132 stores an emergency message if the message is input from the user after the user event detection request was accepted by the user event detection receiving unit 122, and determines that an user event is detected.

A multi-layer registration unit 134 performs location registrations across multiple layers when the location registration areas are organized in multiple layers as previously described. A forceful registration layer changing unit 136 forcefully performs a location registration in a location registration area in a layer different from the current layer when a user event is detected. When this location registration is done, the location registration area of that terminal managed at the network side is also changed. If an emergency message is included, the emergency message is transmitted to the network by making use of the location registration process, and the network stores the received message.

An outgoing call restriction notifying unit 138 notifies all the mobile units served by each base station that outgoing call restrictions are imposed because the network is congested. An outgoing call restriction unit 140 prohibits all outgoing calls except emergency calls after receiving the notification from the outgoing call restriction notifying unit 138.

If the location registration is performed by the forceful registration layer changing unit 136 immediately after the detection of a user event, traffic concentration will occur due to location registrations; therefore, it is desirable to distribute the traffic by performing the location registration after a randomly generated time has elapsed from the detection of the user event.

When a disaster or like event occurs, a user event detection instruction is broadcast by an operator's operation from each base station in the designated area to all the mobile units served by the base station.

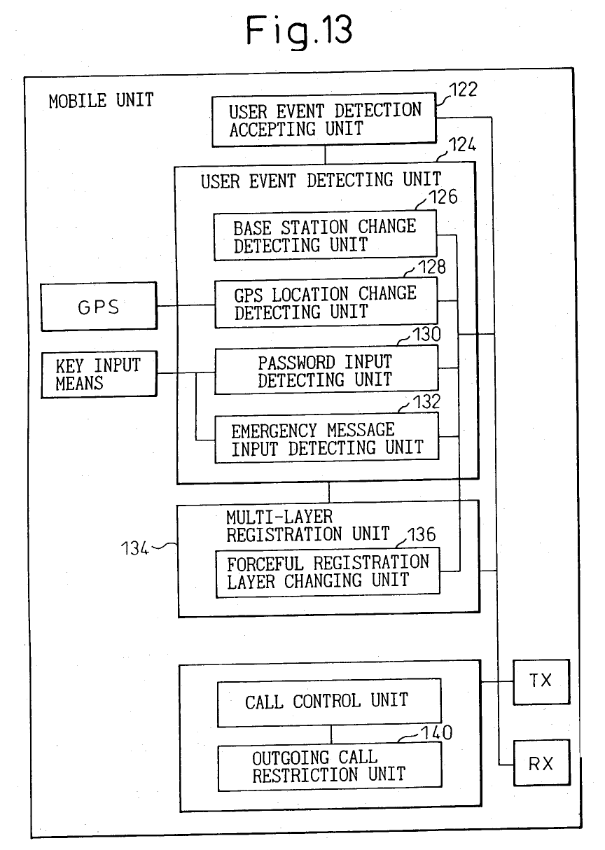

FIGS. 14 to 17 show the processing performed when the mobile unit received the user event detection instruction. Upon receiving the user event detection instruction, the mobile unit sets a user event detection flag ON (step 1500 in FIG. 14). If the mobile unit is equipped with a GPS function, measurements are made using the GPS (step 1502), and the current coordinates are stored in the mobile unit (step 1504). After that, a GPS monitoring timer is started (step 1506).

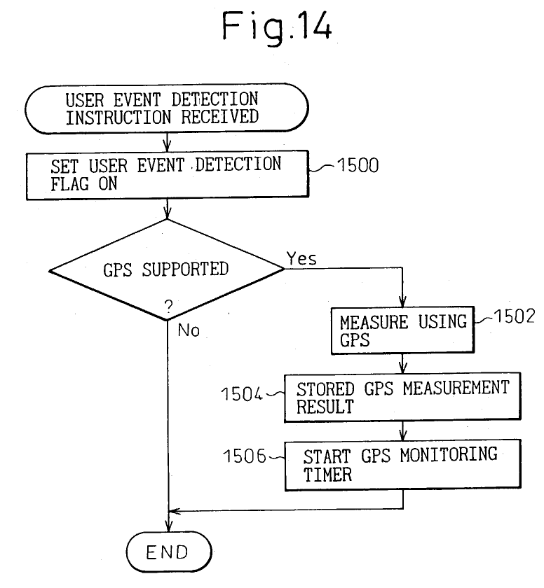

When the GPS monitoring timer expires, measurements are made using the GPS (step 1600 in FIG. 15). If the location indicated by the coordinates measured by the GPS is not different by more than a predetermined value (distance) from the location indicated by the coordinates measured when the user event detection instruction was received, the GPS monitoring timer is reset (re-started) (step 1604). If the location indicated by the coordinates measured by the GPS is different by more than the predetermined value (distance) from the location indicated by the coordinates measured when the user event detection instruction was received, then a user-event-detected flag is set ON (step 1602), and the GPS monitoring timer is reset (step 1604).

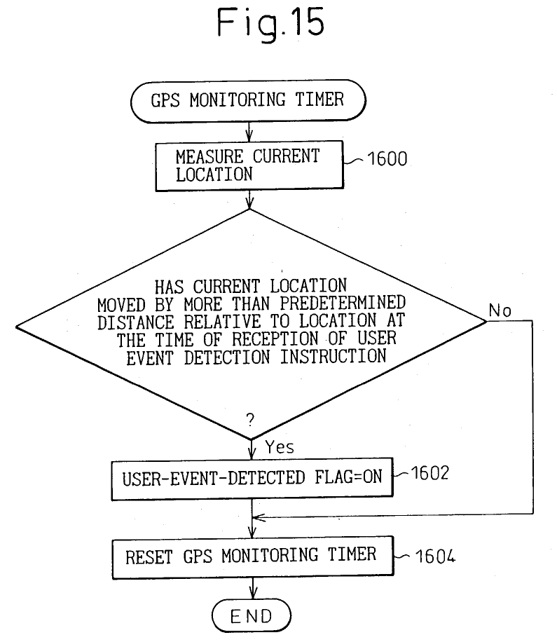

When the user enters his secret code number (or a terminal unlock number), the user-event-detected flag is set ON (step 1700 in FIG. 16). The flag may also be set ON when a game application is started.

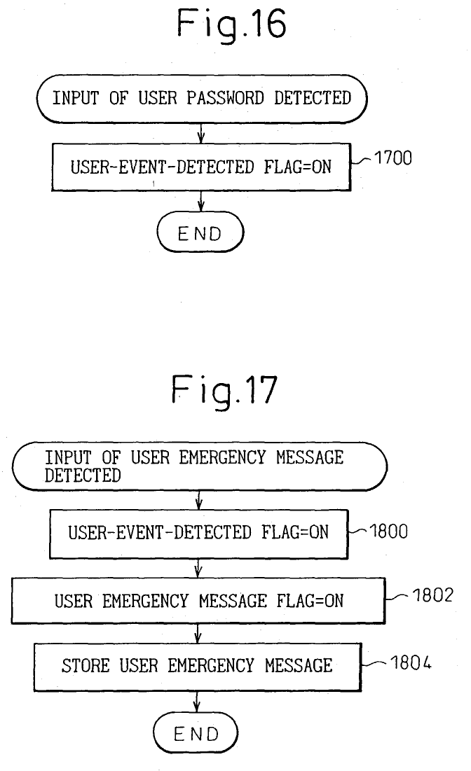

An emergency message input screen is displayed by operating the terminal. Alternatively, provisions may be made to automatically display the emergency message input screen upon receiving the user event detection instruction. The user inputs a message from the terminal. It goes like this: “An earthquake occurred, but I am safe. Do not worry.” or “I am injured but I am all right.” When such a message is input, the user-event-detected flag is set ON (step 1800 in FIG. 17). A user emergency message flag is also set ON (step 1802), and the emergency message input by the user is stored in the terminal (step 1804). The emergency message can be input not only in the form of text but also in the form of voice or image (moving image).

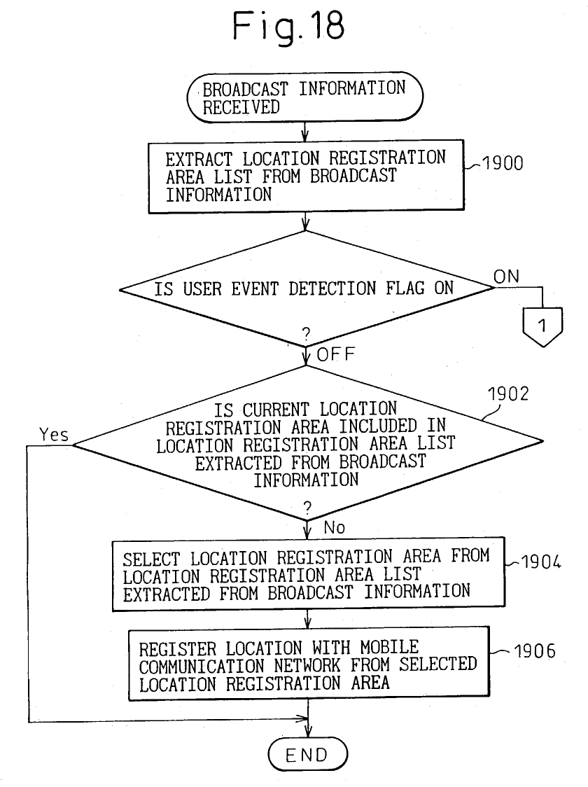

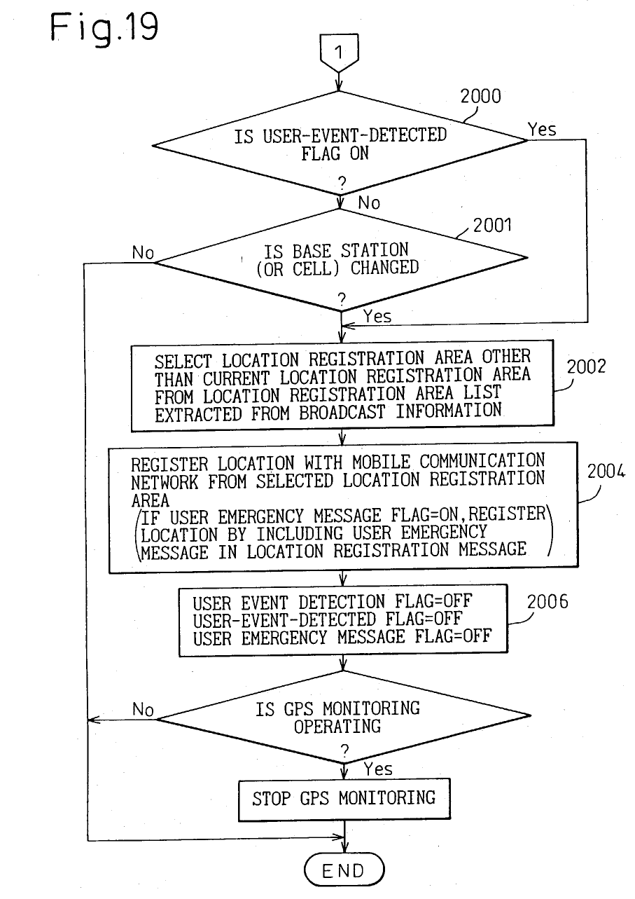

FIGS. 18 and 19 show the processing performed when the mobile unit received broadcast information being broadcast from the base station. First, location registration area information is extracted from the broadcast information (step 1900). The location registration area information includes a plurality of location registration areas, as previously described. In the earlier described example, two location registration areas are included, but three or more areas may be included.

When the user event detection flag is OFF, the normal processing procedure is followed. That is, a comparison is made to determine whether the current location registration area (stored in the mobile unit) matches any one of the areas indicated by the location registration area information contained in the broadcast information (step 1902); if a match is found, there is no need to perform a location registration. If no match is found, one of the location registration areas included in the broadcast information is selected (step 1904), and a location registration is performed (step 1906).

When the user event detection flag is ON, the process according to the present invention is performed. First, the user-event-detected flag is examined (step 2000 in FIG. 19). If the user-event-detected flag is ON, a location registration is performed with a location registration area different from the current location registration area by selecting it from the location registration area list included in the broadcast information (step 2002). At this time, if the user emergency message flag is ON, the emergency message is transmitted onto the network as part of the location registration process (step 2004).

If the user-event-detected flag is OFF, it is determined whether the base station is changed or not (step 2001). If the base station is changed, a forceful registration layer changing operation is performed (steps 2002 to 2006). Instead of performing the forceful registration layer changing operation, the location registration may be done by setting a flag that indicates a forceful location registration. If the base station is not changed, nothing is done. Here, if the mobile unit is located between a plurality of base stations, the base station may change even when the location of the mobile unit remains unchanged. Accordingly, provisions may be made to perform the forceful registration layer changing operation only when a prescribed condition is satisfied (for example, N or more different base stations have been detected).

When the resolution of the user event detection is increased as described above, the amount of traffic will abruptly increase due to location registrations immediately after the reception of the user event detection instruction. To avoid this, a time randomly selected from within a predetermined time range is generated in each terminal. The terminal that detected a user event does not transmit out a location registration message immediately after the detection of the user event, but performs the location registration after the randomly generated time has elapsed. This serves to avoid traffic concentration due to location registrations.

User event detection conditions may be included in the user event detection instruction. For example, the following conditions may be set.

(1) Which of the events, the change of the base station, the change in the location detected by GPS, or the input of the user password, should be regarded as a user event?

(2) In the case of the change of the base station, what is the number of detected base stations that is enough to determine it as the occurrence of a user event?

(3) In the case of the change in the location detected by GPS, the moving distance and the GPS measurement interval (period).

(4) Should the location registration be performed immediately after the detection of a user event, or at the next location registration timing (periodic location registration)?

These conditions may be set by user operation from the terminal.

The condition (4) is provided to prevent an increase in the location registration traffic according to the present invention. If the condition (4) is set so as to perform the location registration at the next location registration timing (periodic location registration), the location registration is not performed upon detecting a user event, but is performed at the next location registration timing, that is, when the location registration area is actually changed, or when the periodic location registration timer has expired; in this case, the amount of location registration traffic is the same as usual, and the user event change is reported to the network at least when the next location registration cycle arrives.

When the user event is detected and reported to the network as described above, the fact that the location has changed and the contents of the user emergency message are reported to the information providing server 106 in FIG. 6, and are stored therein.

According to the present invention, it becomes possible to communicate user state such as the safety of the user to a third party in the event of a disaster or other unexpected situation, while maximally protecting user privacy such as user location, etc. In the location information services represented by the “Imadoko (Where are you) service”, user location information is disclosed, and this has given rise to a privacy problem. On the other hand, disclosing only the fact that the user made a voice communication or that the user moved from one area to another does not offend privacy that much, and this eases the psychological resistance to disclosing the information to a third party in an emergency situation; as a result, all the inquiring persons who accessed the mobile telephone in the event of a disaster can check on the safety of the user of the mobile telephone. Further, the conventional location information services are intended to provide the current location of the user, but if information about the current location of the user is provided to those who called to check on the safety of the user in an emergency situation, there is no knowing whether the user is actually safe or not. The present invention, on the other hand, provides a reliable means to check on the safety of the mobile user by providing, not user location information, but user action information based on the fact that the user of the mobile telephone has moved from one area to another or has made a voice communication (the evidence proving that the user is at least alive). This enables the safety of the user to be checked quickly even in a network congestion situation occurring after a disaster.

Furthermore, since a person who was able to confirm the safety of the mobile user according to the method of the invention need not contact the user urgently, the invention offers the secondary effect of alleviating the phenomenon of congestion being compounded by newly occurring congestion (due to calls being retried repeatedly after failing to get the calls through).

1. A method of providing mobile user action information, comprising the steps of:
(a) automatically gathering information reflecting an action of an user of a mobile unit;
(b) storing said gathered action information in association with said mobile unit; and
(c) providing said stored action information.

2. A method according to claim 1, further comprising the step of detecting an incoming call to a mobile unit located within a designated area, and wherein
said step (c) includes the substep of providing a calling terminal with information stored in association with said called mobile unit located within said designated area.

3. A method according to claim 1, wherein said step (c) includes the substep of automatically providing said action information to a preregistered recipient.

4. A method of providing mobile user action information, comprising the steps of:
(a) automatically gathering information reflecting an action of a user of a mobile unit; and
(b) transmitting said gathered action information in order to have said action information be stored in association with said mobile unit and to have said action information be provided.

5. An action information providing method comprising the steps of:
(a) receiving information automatically gathered as reflecting an action of a user of a mobile unit;
(b) storing said received action information in association with said mobile unit; and
(c) providing said action information.

6. A mobile switching center comprising:
means for automatically gathering information reflecting an action of a user of a mobile unit; and
means for transmitting said gathered action information in order to have said action information be stored in association with said mobile unit and to have said action information be provided.

7. A mobile switching center according to claim 6, further comprising means for changing a location registration area size.

8. A mobile switching center according to claim 7, wherein said location registration area size is changed in sequence on a location-group-by-location-group basis.

9. A mobile switching center according to claim 7, further comprising means for changing said changed location registration area size back to its original size for any mobile unit whose location is detected as having changed from one location registration area to another.

10. An action information providing apparatus comprising:
means for receiving information automatically gathered as reflecting an action of a user of a mobile unit;
means for storing said received action information in association with said mobile unit; and
means for providing said action information.

11. A method for providing mobile user action information, comprising the steps of:
(a) detecting, at a mobile unit, information reflecting an action of a user of said mobile unit;
(b) reporting said detected action information from said mobile unit to a network;
(c) storing said reported action information in association with said mobile unit at the network side; and
(d) providing said stored action information.

12. A method according to claim 11, wherein said reporting in said step (b) is performed by making use of a forceful location registration to a different layer.

13. A method according to claim 11, wherein said reporting in said step (b) is performed by making use of a location registration that is performed by means of a location registration message carrying a flag indicating the detection of a user event.

14. A method according to claim 11, wherein said reporting is performed after a time randomly generated in said mobile unit has elapsed from the detection of said action information.

15. A mobile unit comprising:
means for detecting an action of a user of said mobile unit; and
means for reporting said detected action to a network side.

16. A mobile unit according to claim 15, wherein the reporting of said action information is performed by making use of a location registration.

17. A mobile unit according to claim 16, wherein said location registration is a forceful location registration to a different layer.

18. A mobile unit according to claim 16, wherein said location registration is performed by means of a location registration message carrying a flag indicating the detection of a user event.

19. A mobile unit according to claim 16, wherein said location registration is performed after a time, randomly generated in said mobile unit, has elapsed from the detection of said action information.
